(19) United States
(12) Patent Application Publication
(10) Pub. No.: US 2013/0198504 A1
(43) Pub. Date: Aug. 1, 2013

(54) METHODS OF CONFIGURING A BIOS IN A COMPUTER SYSTEM AND COMPUTER PROGRAM PRODUCTS

(71) Applicant: Fujitsu Technology Solutions Intellectual Property GmbH, Munchen (DE)

(72) Inventors: Lothar Arnold, Delbruck (DE); Detlef Pusch, Paderborn (DE); Karl-Josef Lüttgenau, Borchen (DE)

(73) Assignee: Fujitsu Technology Solutions Intellectual Property GmbH, Munchen (DE)

(21) Appl. No.: 13/753,851

(22) Filed: Jan. 30, 2013

(30) Foreign Application Priority Data
Jan. 30, 2012 (DE) 102012100738.1

(51) Int. Cl. G06F 9/44

(52) U.S. Cl. CPC G06F 9/44
USPC 713/2

(57) ABSTRACT

A method of configuring a basic input output system (BIOS) in a computer system including creating first configuration data in the BIOS to configure the BIOS, transferring the first configuration data from the BIOS to a management unit of the computer system, and storing the first configuration data in the management unit, wherein the steps are carried out at each startup of the computer system.

### RELATED APPLICATION

This application claims priority from German Application No. 102012100738.1 filed Jan. 30, 2012, the subject matter of which is incorporated herein by reference.

### TECHNICAL FIELD

This disclosure relates to methods of configuring a BIOS in a computer system and to computer program products that can be run on a computer system.

### BACKGROUND

Methods for configuration of a Basic Input-Output System (BIOS) already exist, wherein parameters or settings in the BIOS can be changed to modify the BIOS and, in particular, the control tasks in a computer system carried out by the BIOS, and adapt them to operation of the computer system.

In particular, there are methods for configuring a BIOS via a remote computer system in which the BIOS can be accessed from the remote computer system via a data network and corresponding settings can be made. A disadvantage in that method is that the BIOS can only be configured by direct access to the BIOS. This is possible either during a startup process of the computer or with an already booted computer system. Such a configuration of the BIOS is not possible while the computer is inactive (in particular, with a processor core shut down).

Other solutions provide for reading configuration data into a memory of a management unit for the computer system and holding it ready until the computer system is started and booted so that, subsequently, the configuration data can be exported from the management unit into the BIOS.

Such solutions have the disadvantage, however, that a configuration may be laborious to undertake if it is not known which settings and parameters are to be made in the BIOS or are currently present therein.

It could therefore be helpful to provide an improved method for configuration of the BIOS in a computer system that considerably simplifies the configuration of the BIOS.

### SUMMARY

We provide a method of configuring a basic input output system (BIOS) in a computer system including creating first configuration data in the BIOS to configure the BIOS, transferring the first configuration data from the BIOS to a management unit of the computer system, and storing the first configuration data in the management unit, wherein the steps are carried out at each startup of the computer system.

We further provide a computer program product that can be run on a computer system, and when run on the computer system carries out the method.

### BRIEF DESCRIPTION OF THE DRAWINGS

FIG. 1 shows a schematized representation of an interaction between components of computer systems to carry out a method of configuring a BIOS.

FIG. 2 shows a representation of an alternative to FIG. 1.

### LIST OF REFERENCE NUMBERS

1 Computer system
2 BIOS environment
3 Memory in the BIOS environment
4 Management unit
5 File system in the management unit
6a, 6b Communications interface
7 External computer system
8 Management computer system
9 File system in the management computer system
10a, 10b Data network
BIOS Basic input-output system
BMC Baseboard Management Controller
MMB Management Blade

### DETAILED DESCRIPTION

It will be appreciated that the following description is intended to refer to specific examples of structure selected for illustration in the drawings and is not intended to define or limit the disclosure, other than in the appended claims.

We provide a method comprising:

creating first configuration data in the BIOS for configuration of the BIOS,

transferring the first configuration data from the BIOS to a management unit of the computer system, and

storing the first configuration data in the management unit, wherein the steps are carried out at each startup of the computer.

Such a method has the advantage that the configuration data of the BIOS, i.e. a collection of all necessary information to configure the BIOS can be written into a management unit of the computer system at each startup of the computer system. Thus, at each start-up of the computer system the BIOS outputs configuration data that reflects the current configuration state of the BIOS, for example. In this manner, a service employee, for example, can assess the management unit and easily and quickly check a current system status of the BIOS as well as a current system status of all hardware components in the computer system controlled via the BIOS. It is additionally possible to prepare and carry out a configuration of the BIOS based on the output data.

Another advantage of the method is that the configuration data of the BIOS is accessible in the management unit of the computer system without the need for opening a user interface to the BIOS itself. In that way, it is possible to view and edit configuration data of the BIOS without having to boot up the computer system or put it into an active state.

Complete configuration data of the BIOS of the type accessible via a conventional user interface can nevertheless be maintained in the management unit by the method. This has the advantage that all settings that can be made via a conventional user interface can also be made by our methods.

The term “basic input-output system” (BIOS) is understood to mean the fundamental input/output system that controls the hardware components in a computer system or calls up and starts an operating system of the computer system during a startup of the computer system. Thus, the basic input-output system comprises the known BIOS as well as its successors, the Extensible Firmware Interface (EFI) or the Unified Extensible Firmware Interface (UEFI). In addition, the term comprises all other firmware that carries out the fundamental controlling tasks of hardware components in a computer system and/or executes an operating system of the computer system during startup of the computer system.

First configuration data can be transferred from the BIOS to a management unit of the computer system via a configuration interface of the BIOS, which is implemented as a binary interface or a so-called “Application Binary Interface” (ABI) or as a “Generalized Application Binary Interface” (GABI). The configuration interface defines the manner in which the first configuration data in the BIOS is created and/or transferred on the machine level to the management unit.

The term “management unit” of the computer system is understood here as a controller component that detects, monitors and processes system data and system parameters such as temperature, rotational speed of fans, operating system status or the like so that it is possible to access the computer system via an external data network, especially in case of a computer system fault. A prominent representative of such a management unit is the Baseboard Management Controller (BMC) or the Integrated Remote Management Controller (IRMC), more particularly, a BMC having a communication interface for application to a data network (e.g. Local Area Network=LAN).

Such management units are used especially in server systems.

The term “computer system” is understood as any computer system. In particular, the term comprises server systems, rack server systems and blade server systems.

The first configuration data from the BIOS is advantageously transferred to the management unit after completion of a self-test by components of the computer system. Such a self-test is described, for example, by the so-called “Power-on Self-Test” (POST). During this self-test, hardware components in the computer system are addressed by the BIOS and tested for proper functioning. In case of a fault, information on the type of fault can be output for a user. A correct assessment of the current system status for the computer system can be made after the self-test. It is therefore advantageous to carry out transfer of the first configuration data from the BIOS to the management unit subsequent to this self-test to obtain an image of the current system status as undistorted and realistic as possible.

The method preferably further comprises the steps of creating second configuration data in the management unit to configure the management unit, and store the second configuration data in the management unit. The method thus not only allows acquisition of configuration data for the BIOS, but also acquisition of configuration data for the management unit. The latter configuration data can likewise be stored in the management unit and read out by a service employee, for example, via an external data network.

Creation of the second configuration data in regard to the management unit also has the advantage that substantially all settings can be acquired that must be or can be made in or to the management unit.

The management unit can also be configured via the BIOS, however. For this purpose, it may be necessary as part of an initialization process of the management unit to make certain settings of the management unit via a user interface in the BIOS. To be able to access certain functionalities of the management unit (e.g. a connection of the management unit to an external data network) as part of the method discussed above, it may be necessary to make these settings of the management unit in the BIOS via the BIOS user interface.

The method preferably further comprises the step of a transfer of configuration data stored in the management unit from the management unit to another computer system via a data network. Both the first configuration data of the BIOS and the above-discussed second configuration data for the management unit can be transferred to the additional computer system.

The management unit is advantageously equipped with a communications interface to link the management unit to an external data network. For example, the management unit can comprise an interface for a local area network (LAN). Via the data network, an external computer system can read and further process the configuration data stored in the management unit. It is additionally conceivable for a service employee at the external computer system to make changes to the configuration data and/or an analysis of the transmitted configuration data as part of a remote maintenance of the external computer system.

The configuration data can be edited in the external computer system in a simple manner using a text editor.

The configuration data is advantageously present in XML format (XML=Extensible Markup Language). The XML format has the advantage that hierarchically structured data can be exchanged between computer systems in a standardized manner, independently of platforms and implementations. The configuration data in XML format can thus be edited in a simple manner in an external computer system using a text editor, for example.

The method preferably further comprises the following steps:

transmission of third configuration data from an additional computer system to the management unit of the computer system via a data network, and

storage of the third configuration data in the management unit, the third configuration data comprising predefined settings to configure the BIOS and/or the management unit.

The third configuration data comprises predefined settings to be made in the BIOS and/or in the management unit. The configuration data can be created by a service employee using a text editor in the external computer system, for example. This configuration data can be transmitted via the data network to the computer system as part of the method being explained.

The method has the advantage, as described above, that the third configuration data can be initially stored in the management unit. It is not necessary for the computer system to be started or to already be in an active state when the third configuration data is transmitted. When the computer system is started up and the BIOS of the computer system is loaded and started, the third configuration data can be transmitted from the management unit to the BIOS via a configuration interface. The third configuration data can then overwrite previous configuration data in the BIOS and define new settings of the BIOS.

A defined action may be necessary to adopt the new settings in the BIOS. For example, this can be a restart of the computer system (so-called “warm/cold reset” or “power cycling”). Before or after this action, the modified settings in the form of first configuration data can, as described above, be transmitted from the BIOS to the management unit and stored in the management unit.

Before transfer of the third configuration data from the management unit to the BIOS, there is preferably first an analysis of the third configuration data in the management unit. “Analysis” can mean, for example, that the third configuration data is compared to other configuration data stored in the management unit. It is possible to determine whether the third configuration data contains settings that differ from the BIOS settings currently stored in the management unit. Such an analysis can take place, for example, using a so-called “parser” that carries out a syntax analysis of the data structure. Especially if the configuration data is available in XML format, an XML parser can be used to analyze the XML data and present the information contained therein (elements, attributes, time stamps or the like).

It can further be determined directly inside the management unit during the above explained analysis whether the third configuration data is intended for configuration of the BIOS or configuration of the management unit.

Finally, the third configuration data is advantageously only transferred from the management unit to the BIOS if the analysis of the third configuration data has shown that the third configuration data is predetermined for configuration of the BIOS and differs from the first configuration data.

This has the advantage that currently up-to-date configuration data can be exported to the BIOS so that modification of the settings in the BIOS is undertaken only if a valid and consistent configuration is stored in the management unit. Errors in configuration of the BIOS can be reduced or suppressed in this manner. Additionally, the data flow between the management unit and the BIOS can be kept low because only configuration data that is actually predetermined for settings in the BIOS is transmitted to the BIOS. Thereby, the overall performance of the system is not negatively influenced.

The configuration data preferably obligatorily comprises predetermined parameters and current settings of the parameters and, optionally, standard settings (known as “default settings”) of the parameters. That is to say, the configuration data comprises information regarding the parameters, options and settings possibilities available in the BIOS, the current settings, and settings predefined by default, in case of a reset or a reinstallation of the BIOS, for example. This enables a meaningful and comprehensive handling and editing of the configuration data.

The configuration data advantageously comprises a complete collection of all information necessary to be able to make settings in the BIOS in the same manner as if settings were made via a user interface of the BIOS (directly in the BIOS itself).

If the configuration data is available in XML format, a wide variety of subgroups, elements and attributes can be established for each data set. The data sets can comprise, for example, the title or name of each element, parameter values, information about optional modifications, memory address of the data, dependencies of various parameters, etc., according to an XML syntax. The configuration data can further comprise information regarding the current BIOS version and/or information on the system type of the computer system or of individual components of the computer system. This enables better processing or assessment of the configuration data by external processing programs with respect to compatibility or status of the computer system.

The configuration data stored in the management unit is preferably collected in a profile file. The profile file thus describes a higher-order entity that characterizes a complete configuration data set and makes it distinguishable from a different configuration data set.

Creation of a profile file additionally allows transfer and loading of complete configuration data records into the BIOS of the computer system. That means that updating of BIOS settings can be automated via the profile file. The individual settings need not be rewritten one after another. Instead, an out-of-date configuration profile in the BIOS can be replaced easily by an updated configuration profile.

Profile files also offer the advantage that a plurality of computer systems addressed by the aforementioned method for BIOS configuration can be updated in a simple and time-saving manner. For example, a profile file can be created for a specific system type and installed via a data network on all computer systems of this type by the aforementioned method of configuring the BIOS. This also facilitates remote maintenance of a plurality of computer systems of the type present in server systems or entire server farms or computing centers.

In the above-described method, at least one of the following settings or actions can be defined via a configuration interface:

reinstallation of the BIOS,

resetting all settings in the BIOS to predetermined standard settings,

the order in which components of the computer system start, and

power consumption of the computer system components.

The configuration interface of the BIOS is used to create and transmit the first BIOS configuration data to the management unit or to transfer the third configuration data (loaded from the outside) from the management unit to the BIOS. Unlike configuration interfaces implemented in a conventional BIOS or UEFI environment, the configuration interface can have additional functionality of the type described above.

In the case of a reset of all settings in the BIOS, the configuration interface can make it possible, for example, to transmit only one command to the BIOS to restore predetermined default settings of the parameters, instead of transmitting a plurality of default settings for the parameters. The BIOS can be easily reset.

In the case of a reinstallation of the BIOS, i.e. installation of an updated BIOS version (so-called “flashing”), the configuration interface can also make it possible to simultaneously provide predetermined settings to the BIOS by transmitting configuration data using the above-described method.

It is also conceivable, via the configuration interface of the BIOS, to provide improved settings regarding a boot sequence of computer system components or regarding a power consumption of individual computer system components.

The configuration data is preferably password-protected. Additionally or alternatively, the configuration data can be transferred in encrypted form.

Password protection or encryption ensures that configuration data can only be transferred to a computer system or edited by secure parties. The ultimate purpose of this security is that only authorized service personnel can read, transfer and edit configuration data. It is conceivable to transmit only the password for access to the configuration data in encrypted form. But it is also conceivable to encrypt the configuration data.

As part of a transmission security scheme, it is also conceivable for the BIOS to transmit a signature together with the configuration data when configuration data is transmitted, the signature serving as the basis to specify an identification of the BIOS in a respective computer system and/or a time stamp. This makes it possible to identify all configuration data stored in the management unit unambiguously.

A computer program product that can be run on a computer system and carries out a method of the above described type when executed is also described with reference to the drawings.

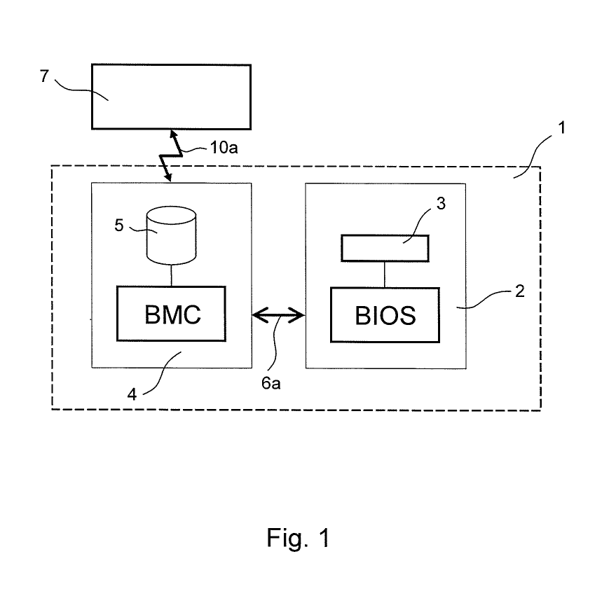

FIG. 1 shows a schematized representation of components of a computer system 1 which can interact with an external computer system 7 and can perform a method of configuring a BIOS in the computer system 1.

The computer system 1 can be a server system, for example, and comprises, in addition to a plurality of components (not shown for reasons of simplicity), a BIOS environment 2 and a management unit 4. The BIOS environment 2 connects via a communications interface 6a to the management unit 4. The communications interface 6a is used for communication between the two environments 2 and 4, whereby data can be interchanged. The communications interface 6a is implemented, for example, as a KCS interface (KCS=Keyboard Controller Style) or as a VGA interface (VGA=Video Graphics Array).

The BIOS environment 2 comprises in essence an electronic memory module 3, in the memory of which the actual sequence program of executing the BIOS is stored. The BIOS can comprise both the well-known basic input-output system and its successors, the EFI (=Extensible Firmware Interface) or UEFI (Unified Extensible Firmware Interface). In general, the BIOS comprises any type of firmware that configures and controls hardware components inside the computer system 1.

The management unit 4 comprises a management controller, implemented as a Baseboard Management Controller (BMC). The BMC can be implemented as an Integrated Remote Management Controller (IRMC). In this case, the BMC has a communications interface connecting the management unit 4 to an external data network 10a.

Predetermined system states of the computer system 1 such as temperature, status of individual components, operating system state or the like can be acquired and processed via the BMC. In addition to the BMC, the management unit 4 comprises a data system 5 in which, for example, system status data is stored, processed and prepared. The data system 5 can further comprise a memory in which data is stored.

As already explained, the management unit 4 may connect via a data network 10a to another external computer system 7. The data network 10a can comprise a local data network (Local Area Network=LAN), for example. It is also possible that the data network 10a comprises an Internet connection to the external computer system 7.

The BIOS of the computer system 1 comprises predetermined configuration settings that define how and in what manner the BIOS controls additional electronic components in the computer system 1 so that fault-free operation thereof is guaranteed during the boot-up of the computer system 1. For example, the BIOS determines the order in which the individual components in the computer system 1 are started. The BIOS additionally addresses and allocates a memory area in which the actual operating system of the computer 1 is stored and calls up that system when the computer system 1 is started so that the operating system (when loaded) can take over the further control of the computer system 1 after startup of the computer system 1.

The configuration of the BIOS can be changed, as will be explained below.

The BIOS is loaded and executed as a sequence program in the memory 3 each time the computer system 1 is started. During this process or subsequent thereto, there is a self-test of the computer system 1 initiated by the BIOS. In this self-test, functionality of predetermined electronic components such as hard disks, optical reading devices, cooling devices, memory modules, expansion cards and the like is tested. There can be an acoustic and/or visual output to service personnel or to a user of the computer system 1 in case of a fault. This self-test is generally referred to as a “Power-on-Self-Test” (POST).

After the self-test has been passed, the BIOS acquires all configuration data regarding the settings that can usually be made in the BIOS via a user interface. The configuration data advantageously comprises possible parameters, setting options, current assignment of predetermined values and settings to the parameters, as well as default settings of the parameters. Subsequently, configuration data from the BIOS is transferred via a configuration interface of the BIOS (referred to as a “Generalized Application Binary Interface” (GABI), and via the communications interface 6a to the management unit 4, or the BMC. The BMC acquires the configuration data and stores it in the file system 5 of the management unit 4. The configuration data remains in the file system 5 even if the computer system 1 is subsequently shut down and switched off.

Finally, it is possible to access the file system 5 of the management unit 4 via the external computer system 7 with the aid of the data network 10a so that the stored configuration data of the BIOS can be called up and transmitted to the external computer system 7.

The external computer system 7 can provide applications with which the configuration data can be read, analyzed and edited. It is possible that service personnel, for example, may edit the configuration data of the BIOS on the external computer system 7.

It is also possible for modified configuration data, which comprises certain changes of the settings in the BIOS, to be prepared in the external computer system 7. These changes can relate, for example, to a given modified system behavior of the computer system 1. The modified configuration data can then be transmitted via the data network 10a from the computer system 7 to the management unit 4, wherein the data is likewise stored in the file system 5 of the management unit 4.

When the computer system 1 is restarted, the BIOS is again loaded from the memory 3 of the BIOS environment 2 and executed. Subsequently, the modified configuration data can be loaded via the BMC of the management unit 4 from the file system 5 and transmitted via the communications interface 6a to the BIOS environment 2 so that the modified configuration data is ultimately incorporated into the program structure of the BIOS via a configuration interface of the BIOS. Thereby, outdated settings in the BIOS can be overwritten, for example, so that updated settings are present in the BIOS.

It is conceivable that, after overwriting the old configuration data with the new, modified configuration data, the BIOS transmits the updated configuration data back to the management unit 4, where it is then stored in the form of a copy in the file system 5. In this manner, current configuration data of the BIOS, reflecting the current status of the BIOS and thus indirectly the current system status of the computer system 1, is stored in the file system 5 of the management unit 4 at all times.

After changing the settings in the BIOS, it is conceivable that a defined action may be carried out to adopt the settings in the BIOS. Such an action may comprise a restart of the computer system 1, for example.

Information on the configuration status of the BIOS is present at all times in the file system 5 of the management unit 4 due to the transfer of the configuration data from the BIOS environment 2 to the management unit 4 at every startup of the computer system 1. The management unit 4 can advantageously be operated independently of the energy in the additional components of the computer system 1 such that the file system 5 can be read even if the computer system 1 is otherwise inactive. It is therefore easily possible for the service personnel at any time to read the current configuration data of the BIOS, edit it, and prepare new settings that will be correspondingly adopted at the next restart of the computer system 1.

Configuration data is preferably stored in one or more profile files. Profile files have the advantage that complete configuration profiles can be predefined so that a modification in settings in the BIOS can be carried out by a complete replacement of profile files. This enables a simplified modification of settings in the BIOS. Profile files additionally allow a rapid and simplified modification of a plurality of computer systems 1, as are present, for example, in computing centers with multiple server systems.

The configuration data is preferably present in XML format so that a standardized platform-independent exchange of data is possible. In addition, standardized and simple creation of data sets is possible. A plurality of variables, settings and attributes can also be defined in XML.

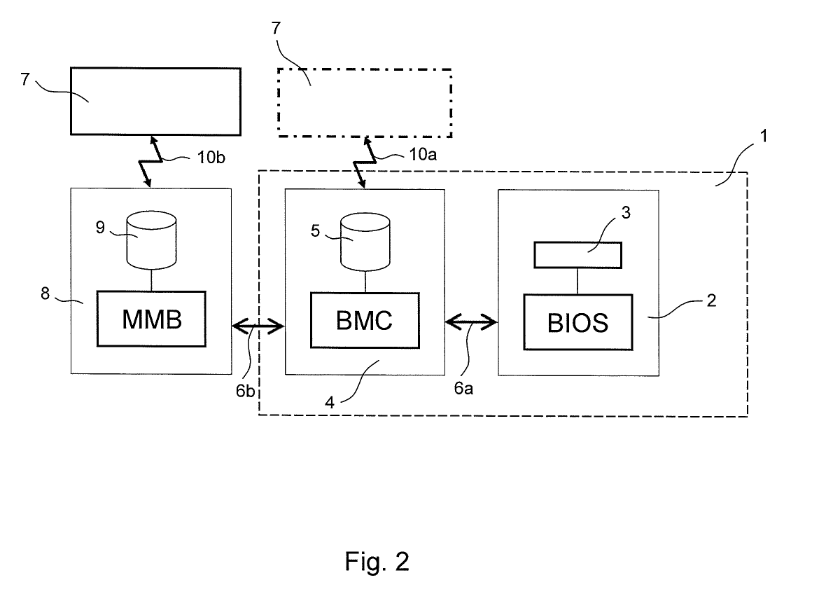

FIG. 2 shows an alternative schematized representation of a computer system 1 and an external computer system 7 set up for a method of configuring the BIOS in the computer system 1 in accordance with the type explained above. The computer system 1 substantially corresponds to the computer system 1 in accordance with FIG. 1. However, the computer system 1 according to FIG. 2 comprises, as an example, a blade server structure, wherein the computer system 1 comprises a blade server with a BIOS environment 2 and a management unit 4 of the type explained above. The computer system 1 can communicate via a communications interface 6b with an additional blade computer system 8, with the computer system 8 representing a management computer system. In particular, the computer system 8 can comprise a so-called “Management Blade Server” (MMB). The management computer system 8 further comprises a file system 9 in which data is stored.

The communications interface 6b comprises for the sake of example a so-called “System Management Bus” (SM bus) that is used to communicate between the individual blade servers 1 and 8. The SM bus can connect the individual blade servers 1 and 8 via a backplane in the server system, for example. According to FIG. 1, the computer system 1 can communicate with another external computer system 7 via a data network 10a, as was explained for FIG. 1.

Alternatively or additionally, it is also possible according to the arrangement in FIG. 2 to transfer configuration data of the BIOS stored in the file system 5 of the management unit 4 of computer system 1 to the management computer system 8 via the communications interface 6b. The configuration data can finally be stored in the file system 9 of the management computer system 8 and made available via a data network 10b to an external computer system 7. The data network 10b can comprise a network separate from the data network 10a, or an identical network or a part of the data network 10a.

Thus, the arrangement according to FIG. 2 constitutes an expansion of the arrangement according to FIG. 1, specifically for blade server systems. Configuration data of a BIOS environment 2 in the computer system 1 is sent to a higher-order management unit, the management computer system 8, which controls and manages the computer system 1 inside the blade server system. The configuration data is finally transferred by the management computer system 8 to an external computer system 7, received by the external computer system 7 and ultimately loaded by the management unit 4 of the computer system 1 into the BIOS environment 2 of the computer system 1.

In addition to the above explanations, it is possible for additional configuration data relating to a configuration of the management unit 4, in particular the BMC, to be exchanged. This additional configuration data allows the separate adjustment and configuration of the BMC inside the management unit 4, detached from the configuration of the BIOS in the BIOS environment 2. It is also conceivable, however, for a configuration of the BMC of the management unit 4 to be undertaken by configuration data for the BIOS in the BIOS environment 2.

A method as explained of configuring a BIOS in a computer system allows a simplified and convenient setup of a computer system, wherein configuration data of a BIOS can be transferred to an external computer system for processing. In this manner, the settings in the BIOS can be modified independently of the current operation of the computer system 1. The method additionally allows a comprehensive representation of all configuration data in the BIOS which corresponds to a representation inside a user interface of the BIOS. Thus, a plurality of terminal devices can be administered in a time-saving and convenient manner.

All illustrated infrastructures are selected merely for the sake of example.

Although the apparatus and methods have been described in connection with specific forms thereof, it will be appreciated that a wide variety of equivalents may be substituted for the specified elements described herein without departing from the spirit and scope of this disclosure as described in the appended claims.

What is claimed is:

1. A method of configuring a basic input output system (BIOS) in a computer system comprising:
creating first configuration data in the BIOS to configure the BIOS,
transferring the first configuration data from the BIOS to a management unit of the computer system, and
storing the first configuration data in the management unit,
wherein the steps are carried out at each startup of the computer system.

2. The method according to claim 1, wherein the first configuration data from the BIOS is transferred to the management unit after completion of a self-test by components of the computer system.

3. The method according to claim 1, further comprising creating second configuration data in the management unit to configure the management unit and storing the second configuration data in the management unit.

4. The method according to claim 1, further comprising transferring the configuration data stored in the management unit from the management unit to an additional computer system via a data network.

5. The method according to claim 1, further comprising transferring third configuration data from an additional computer system to the management unit of the computer system via a data network, and storing the third configuration data in the management unit, wherein the third configuration data comprises predefined settings to configure the BIOS and/or the management unit.

6. The method according to claim 5, further comprising analyzing the third configuration data in the management unit, and transferring the third configuration data from the management unit to the BIOS if analysis of the third configuration data has shown that the third configuration data is predetermined for configuration of the BIOS and differs from the first configuration data.

7. The method according to claim 1, wherein the configuration data comprises predetermined parameters, current settings of the parameters and, optionally, default settings of the parameters.

8. The method according to claim 1, wherein the configuration data stored in the management unit is collected into a profile file.

9. The method according to claim 1, wherein at least one of the following settings or actions can be defined via a configuration interface of the BIOS:
reinstallation of the BIOS,
resetting all settings in the BIOS to predetermined standard settings,
order in which components of the computer system start, and
power consumption of the components of the computer system.

10. The method according to claim 1, wherein the configuration data is in XML format.

11. The method according to claim 1, wherein the configuration data is transmitted password-protected and/or encrypted.

12. A computer program product that can be run on a computer system, and when run on the computer system carries out the method according to claim 1.

13. The method according to claim 2, further comprising creating second configuration data in the management unit to configure the management unit and storing the second configuration data in the management unit.

14. The method according to claim 2, further comprising transferring the configuration data stored in the management unit from the management unit to an additional computer system via a data network.

15. The method according to claim 3, further comprising transferring the configuration data stored in the management unit from the management unit to an additional computer system via a data network.

16. The method according to claim 2, further comprising transferring third configuration data from an additional computer system to the management unit of the computer system via a data network, and storing the third configuration data in the management unit, wherein the third configuration data comprises predefined settings to configure the BIOS and/or the management unit.

17. The method according to claim 3, further comprising transferring third configuration data from an additional computer system to the management unit of the computer system via a data network, and storing the third configuration data in the management unit, wherein the third configuration data comprises predefined settings to configure the BIOS and/or the management unit.

18. The method according to claim 4, further comprising transferring third configuration data from an additional computer system to the management unit of the computer system via a data network, and storing the third configuration data in the management unit, wherein the third configuration data comprises predefined settings to configure the BIOS and/or the management unit.
